(19) United States
(12) Patent Application Publication
(10) Pub. No.: US 2024/0005284 A1
(43) Pub. Date: Jan. 4, 2024

(54) METHOD AND DEVICE FOR PROVIDING GIG SERVICE THROUGH ONE-TO-ONE CHANNEL BETWEEN GIG WORKER AND GIG SERVICE USER

(71) Applicant: ENTERPRISE BLOOKHAIN CO., LTD., Seoul (KR)

(72) Inventors: Youngseok HAN, Hwaseong-si (KR); Jihyun LEE, Yongin-si (KR); Yongwook KIM, Seoul (KR); Donghyun KIM, Yongin-si (KR); Junsup LEE, Seoul (KR); Nayoung YOUK, Seoul (KR); Taeho GWAK, Seoul (KR)

(73) Assignee: ENTERPRISE BLOOKHAIN CO., LTD., Seoul (KR)

(21) Appl. No.: 18/039,607

(22) PCT Filed: Nov. 10, 2021
(86) PCT No.: PCT/KR2021/016351

§ 371 Date: May 31, 2023

(30) Foreign Application Priority Data
Dec. 18, 2020 (KR) 10-2020-0177983

(51) Int. Cl. G06Q 10/1093; G06Q 30/0207

(52) U.S. Cl. CPC G06Q 10/1097; G06Q 30/0224; G06Q 50/10

(57) ABSTRACT

Disclosed are a method and a device for providing a gig service through an one-to-one channel between a gig worker and a gig service user, the device comprising: a channel generation unit which generates a one-to-one channel between a gig worker terminal and a gig service user terminal; a first order reception unit which receives a first gig service order from the gig service user terminal through the one-to-one channel; an order history generation unit which generates an order history of the gig service user, which includes the received first gig service order; an offer generation unit which generates a first gig service offer including a discount price for the gig service user on the basis of the order history; an offer transmission unit which transmits the first gig service offer to the gig service user terminal through the one-to-one channel; a second order reception unit which receives a second gig service order for the first gig service offer from the gig service user terminal through the one-to-one channel; and an order processing unit which processes a gig service for the received second gig service order.

### TECHNICAL FIELD

The present invention relates to a method and device for providing a gig service through a one-to-one channel between a gig worker and a gig service user, and more specifically, a method and device for providing a gig service through a one-to-one channel between a gig worker and a gig service user, which generates a one-to-one channel between a gig worker's terminal and a gig service user's terminal, generates a customized gig service offer including a discount price for the gig service user based on an order history of the gig service user for whom the one-to-one channel has been generated, and provides a gig service.

### BACKGROUND ART

The gig economy is emerging as a new labor trend as the demand for labor required for on-demand services increases along with the vitalization of the on-demand economy. Gig economy refers to a type of economy in which companies (or gig service providers) hire workers as short-term contract workers or temporary workers as needed and pay them. The term ‘gig’ means temporary work. In the past, gig or gig worker was used to encompass various freelancers and self-employed workers, but as the on-demand economy spreads, it has recently changed to mean a provider or a contingent worker, such as sole proprietorship, who provides services under short-term contracts with online platform companies.

In the conventional employment system, the company directly hires employees, makes a formal labor contract, and provides products or services to customers using the retained labor force. On the other hand, in the gig economy, companies use gig workers under ultra-short-term contracts according to demand. In the gig economy system, gig workers are not employed by anyone, but are temporarily hired only during a desired period of time when needed and create income through the labor desired by customers, that is, gig service users.

Gig platform refers to a platform that receives gig service orders from gig service users and requests services from gig workers, and gig platform operator refers to an operator that provide a gig platform. Gig workers receive jobs through the gig platform and perform gig services while sometimes competing with other gig workers for job demand.

In order to increase the productivity of gig workers on gig platforms, there are attempts to bundle gig service orders, optimize delivery order and schedule, etc. However, it is not easy to increase the productivity of gig workers on orders that have already been placed due to geographical characteristics and distribution of orders.

Therefore, a need exists for a method for enhancing the quality of gig services by maximizing profits through increasing the productivity of gig workers on gig platforms and increasing their satisfaction by decreasing the costs of gig service users.

### PRIOR ART DOCUMENTS

### Patent Documents

(Patent Document 1) Korean Patent Application Publication No. 10-2018-0012794 published on Feb. 6, 2018
(Patent Document 2) Korean Patent Application Publication No. 10-2015-0027441 published on Mar. 12, 2015
(Patent Document 3) Korean Patent No. 10-2153012 published on Sep. 7, 2020
(Patent Document 4) Korean Patent Application Publication No. 10-2019-0060632 published on Jun. 3, 2019
(Patent Document 5) Korean Patent Application Publication No. 10-2011-0012832 published on Feb. 9, 2011

### DISCLOSURE OF INVENTION

### Technical Problem

The present invention has been devised to address the foregoing technical problems and aims to provide a method and device for providing a gig service through a one-to-one channel between a gig worker and a gig service user, which generates a one-to-one channel between a gig worker's terminal and a gig service user's terminal, generates a customized gig service offer including a discount price for the gig service user based on an order history of the gig service user for whom the one-to-one channel has been generated, and provides a gig service and a computer-readable recording medium storing a program for executing the method.

### Technical Solution

According to an embodiment of the present invention, a method for providing a gig service through a one-to-one channel between a gig worker and a gig service user comprises generating the one-to-one channel between a gig worker terminal and a gig service user terminal, receiving a first gig service order from the gig service user terminal through the one-to-one channel, generating the gig service user's order history including the received first gig service order, generating a first gig service offer including a discount price for the gig service user based on the order history, transmitting the first gig service offer to the gig service user terminal through the one-to-one channel, receiving a second gig service order for the first gig service offer from the gig service user terminal through the one-to-one channel, and processing a gig service for the received second gig service order.

According to an embodiment of the present invention, the method further comprises generating a learning model by deep-learning the gig service user's order history, predicting a degree of association for the gig service user and a gig service on sale, indicating the gig service user's purchaseability for the gig service on sale based on the learning model and generating a recommended gig service list including at least one gig service on sale, sorted by the degree of association for the gig service user and the gig service on sale, for the gig service user. According to an embodiment of the present invention, the method further comprises predicting a future order time and order space for each recommended gig service list based on the learning model and generating a temporary schedule of the gig worker including the order time and the order space.

According to an embodiment of the present invention, the first gig service offer includes a gig service provider and a discount price for the gig service user, generated based on one gig service in the recommended gig service list, the predicted order time, the predicted order space, and the temporary schedule.

According to an embodiment of the present invention, the method further comprises generating an actual schedule reflecting the gig worker's temporary schedule when receiving the second gig service order from the gig service user terminal through the one-to-one channel.

According to an embodiment of the present invention, the method further comprises generating a similar gig service user list including at least one other gig service user showing an order history similar to the order history of the learned gig service user and transmitting the first gig service offer to a terminal of the at least one other gig service user in the similar gig service user list.

According to an embodiment of the present invention, the method further comprises previously building a gig service offer database for the gig service on sale, receiving a gig service bid for a predetermined gig service from the gig service user terminal through the one-to-one channel, extracting a second gig service offer meeting the received gig service bid from the gig service offer database, and transmitting the extracted second gig service offer to the gig service user terminal through the one-to-one channel.

According to an embodiment of the present invention, the gig service bid includes a predetermined gig service, an order time, an order space, and an order price, and the second gig service offer includes a predetermined gig service, an order time, an order space, an order price, and a gig service provider.

According to an embodiment of the present invention, the one-to-one channel is generated through a web or a dedicated application.

Further, according to an embodiment of the present invention, there is included a computer-readable recording medium recording a program for performing the method.

According to an embodiment of the present invention, a device for providing a gig service through an one-to-one channel between a gig worker and a gig service user comprises a channel generator generating the one-to-one channel between a gig worker terminal and a gig service user terminal, a first order receiver receiving a first gig service order from the gig service user terminal through the one-to-one channel, an order history generator generating the gig service user's order history including the received first gig service order, an offer generator generating a first gig service offer including a discount price for the gig service user based on the order history, an offer transmitter transmitting the first gig service offer to the gig service user terminal through the one-to-one channel, a second order receiver receiving a second gig service order for the first gig service offer from the gig service user terminal through the one-to-one channel, and an order processor processing a gig service for the received second gig service order.

According to an embodiment of the present invention, the device further comprises a learning model generator generating a learning model by deep-learning the gig service user's order history, a predictor predicting a degree of association for the gig service user and a gig service on sale, indicating the gig service user's purchaseability for the gig service on sale based on the learning model, and a recommender generating a recommended gig service list including at least one gig service on sale, sorted by the degree of association for the gig service user and the gig service on sale, for the gig service user.

According to an embodiment of the present invention, the predictor predicts a future order time and order space for each recommended gig service list based on the learning model. The device further comprises a temporary schedule generator generating a temporary schedule of the gig worker including the order time and the order space.

According to an embodiment of the present invention, the first gig service offer includes a gig service provider and a discount price for the gig service user, generated based on one gig service in the recommended gig service list, the predicted order time, the predicted order space, and the temporary schedule.

According to an embodiment of the present invention, the device further comprises an actual schedule generator generating an actual schedule reflecting the gig worker's temporary schedule when receiving the second gig service order from the gig service user terminal through the one-to-one channel.

According to an embodiment of the present invention, the device further comprises a similar gig service user list generator generating a similar gig service user list including at least one other gig service user showing an order history similar to the order history of the learned gig service user. The offer transmitter further transmits the first gig service offer to a terminal of the at least one other gig service user in the similar gig service user list.

According to an embodiment of the present invention, the device further comprises a database builder previously building a gig service offer database for the gig service on sale, a bid receiver receiving a gig service bid for a predetermined gig service from the gig service user terminal through the one-to-one channel, and a database extractor extracting a second gig service offer meeting the received gig service bid from the gig service offer database. The offer transmitter further transmits the extracted second gig service offer to the gig service user terminal through the one-to-one channel.

According to an embodiment of the present invention, the gig service bid includes a predetermined gig service, an order time, an order space, and an order price, and the second gig service offer includes a predetermined gig service, an order time, an order space, an order price, and a gig service provider.

According to an embodiment of the present invention, the one-to-one channel is generated through a web or a dedicated application.

### Advantageous Effects

Through the device for providing a gig service through a one-to-one channel between a gig worker and a gig service user according to the present invention, the gig worker may establish a one-to-one channel with a gig service user, have continuous relationship with the gig service user through the one-to-one channel, and provide a high-quality gig service based on mutual trust.

Further, the device for providing a gig service according to the present invention may provide a customized gig service to a gig service user based on learning the gig service user's past order history, maximize profits by the productivity of the gig worker, and provide a gig service offer capable of reducing costs of the gig service user to the gig service user.

The gig service providing device according to the present invention may rapidly grow the gig service and provide high-quality gig services, making it possible to expect advanced gig services and increased economics.

### BRIEF DESCRIPTION OF DRAWINGS

FIG. 1 schematically illustrates a device and method for providing a gig service through a one-to-one channel between a gig worker and a gig service user according to an embodiment of the present invention;

FIG. 2 is a flowchart schematically illustrating a method for providing a gig service through a one-to-one channel between a gig worker and a gig service user according to an embodiment of the present invention;

FIG. 3 is a flowchart schematically illustrating generating a customized gig service offer including a discount price for a gig service user for whom a one-to-one channel has been generated according to an embodiment of the present invention;

FIG. 4 is a flowchart schematically illustrating receiving a gig service bid from a gig service user for whom a one-to-one channel has been generated and generating a gig service offer according to an embodiment of the present invention; and

FIGS. 5 to 7 are block diagrams schematically illustrating a device for providing a gig service according to an embodiment of the present invention.

### MODE FOR CARRYING OUT THE INVENTION

Hereinafter, preferred embodiments of the present invention are described in detail with reference to the accompanying drawings. In the drawings, the same reference numerals refer to the same elements, and the size of each component in the drawings may be exaggerated for clarity of description.

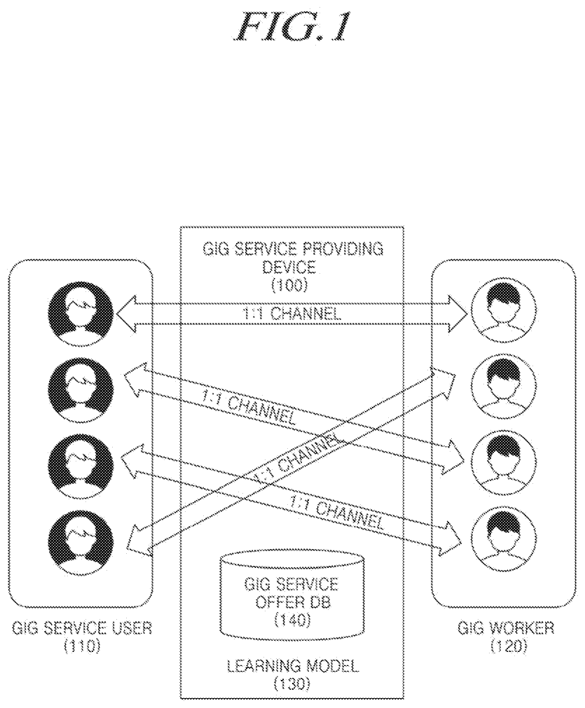

FIG. 1 schematically illustrates a method for providing a gig service through a one-to-one channel between a gig worker and a gig service user according to an embodiment of the present invention.

A gig service according to an embodiment of the present invention refers to a service (Business to Consumer (B2C)) between a gig service provider (not shown) and a gig service user 110 with the help of a gig worker 120, and includes a labor force-based service of the gig worker 120, such as food delivery, courier service, laundry agency, and cleaning agency. In general, gig service quality is not standardized, and customer satisfaction may vary depending on the effort of the gig worker 120.

The gig service user 110 refers to a person who orders and uses the gig service, and the gig service provider (not shown) refers to a business operator (e.g., a restaurant business operator) that provides the contents of the gig service. The gig service providing device 100 (or a gig platform device) refers to a platform that receives a gig service order from the gig service user 110 and requests a service from the gig worker 120. The gig platform operator refers to an operator that provides and operates the gig service providing device 100. For example, delivery-related gig platform operators include Yogiyo, Baedal Minjok, and Coupang.

The gig service providing device 100 according to an embodiment of the present invention generates a one-to-one channel between the gig worker 120 and the gig service user 110. Specifically, the gig service providing device 100 according to an embodiment of the present invention generates a one-to-one channel between a terminal (not shown) of the gig worker 120 and a terminal (not shown) of the gig service user 110. When the gig worker 120 intends to provide the gig service to the new gig service user 110, the gig worker 120 proposes to generate a one-to-one channel to the gig service user 110 through the gig service providing device 100. Thereafter, a one-to-one channel is generated between the terminal of the gig worker 120 and the terminal of the gig service user 110 as the generation of the one-to-one channel is accepted by the gig service user 110.

The one-to-one channel according to an embodiment of the present invention may be generated through a web or a dedicated application in the gig service providing device 100, but is not limited thereto. The one-to-one channel includes all means capable of one-to-one communication between the gig worker 120 and the gig service user 110. For example, the gig worker 120 may transmit a QR code or an Internet address for accessing the web or the dedicated application capable of generating the one-to-one channel in the gig service providing device 100 to the terminal (not shown) of the gig service user 110 through the gig service providing device 100, and the gig service user 110 may generate the one-to-one channel with the terminal (not shown) of the gig worker 120 by accessing the web or the dedicated application using the QR code or the Internet address on the terminal.

The gig service providing device 100 according to an embodiment of the present invention receives a gig service order from the gig service user 110 through the one-to-one channel. Gig service orders are accumulated as an order history for the gig service user 110 in the gig service providing device 100. The gig service providing device 100 generates a learning model 130 by learning the order history of the gig service user 110 using an artificial intelligence algorithm. In the instant embodiment, the learning model 130 is trained by deep learning and, for deep learning training, uses at least one of a machine learning algorithm such as a random forest, a deep neural network (DNN), a convolutional neural network (CNN), a recurrent neural network (RNN), a restricted Boltzmann machine (RBM), a deep belief network (DBN), or a deep Q-networks (DQN), but is not limited thereto.

The gig service providing device 100 according to an embodiment of the present invention predicts a degree of association between the gig service user 110 and the gig service on sale, indicating the purchaseability of the gig service user 110 for the gig service on sale, based on the learning model, and recommends at least one gig service on sale sorted (or aligned) with the degree of association. In this case, the gig service providing device 100 predicts a future order time and an order space for each of the recommended gig services based on the learning model, and generates a temporary schedule of the gig worker 120 including the order time and the order space. The gig service providing device 100 obtains a discount price based on an external input of the gig worker 120 for orders that may be simultaneously processed due to overlapping or successive occurrences in the temporary schedule of the gig worker 120.

The gig service providing device 100 according to an embodiment of the present invention generates a gig service offer including the gig service provider and the discount price for the gig service user 110 generated based on the recommended gig service, the predicted order time, the predicted order space, and the temporary schedule. The gig service providing device 100 transmits the gig service offer to the gig service user 110 terminal through the one-to-one channel. Accordingly, because the gig service user 110 may receive (i.e., an alarm) a gig service offer optimized and discounted to the gig service user 110 through the one-to-one channel, the gig service user 110 may be given a discount chance for the gig service optimized to the gig service user 110 through the one-to-one channel. Further, the gig worker 120 may increase productivity and maximize profits of the gig worker 120 by leading to an additional order of the gig service user 110 through the one-to-one channel.

Accordingly, through the gig service providing device 100 according to the present embodiment, the gig worker 120 may establish a one-to-one channel with the gig service user 110 and may establish a continuous relationship with the gig service user 110 through the one-to-one channel, thereby providing a high-quality gig service based on mutual trust.

Further, the gig service providing device 100 according to the present invention may provide a customized gig service to a gig service user 110 based on learning the past order history of the gig service user 100, maximize profits by the productivity of the gig worker 120, and provide a gig service offer capable of reducing costs of the gig service user 110 to the gig service user 110.

Meanwhile, the gig service providing device 100 according to an embodiment of the present invention may receive a bid for a desired gig service from the terminal of the gig service user 110 through the one-to-one channel, and provide a customized gig service offer for the gig service user 110 to the gig service user 110 terminal. The gig service bid for the gig service desired by the gig service user 110 includes a predetermined gig service, an order time, an order space, and an order price. The customized gig service offer for the gig service user 110 includes a predetermined gig service, an order time, an order space, an order price, and a gig service provider.

To this end, the gig service providing device 100 according to the present embodiment previously builds a gig service offer database 140 for the gig service on sale. The gig service offer database 140 includes gig service, order time, order space, order price, and gig service provider items. The gig service providing device 100 may previously build the gig service offer database 140 based on external inputs of the gig worker 120 and the gig service provider.

When the gig service providing device 100 according to the present embodiment receives a gig service bid from the gig service user 110 terminal,
the gig service providing device 100 extracts a gig service offer meeting the received gig service bid from the gig service offer database 140. The gig service providing device 100 transmits the extracted gig service offer to the gig service user 110 terminal through the one-to-one channel.

The process may be repeated because the gig service user 110 may modify and retry the gig service bid, and as a result, the gig service user 110 accepts the gig service offer, and thus the gig service providing device 100 provides the corresponding gig service to the gig service user 110.

Accordingly, through the gig service providing device 100 according to the present embodiment, the gig service user 110 may inquire the gig worker 120 about the desired gig service through the one-to-one channel, and the gig worker 120 may provide a customized gig service for the gig service user 110 by providing a customized gig service offer for the inquiry to the gig service user 110.

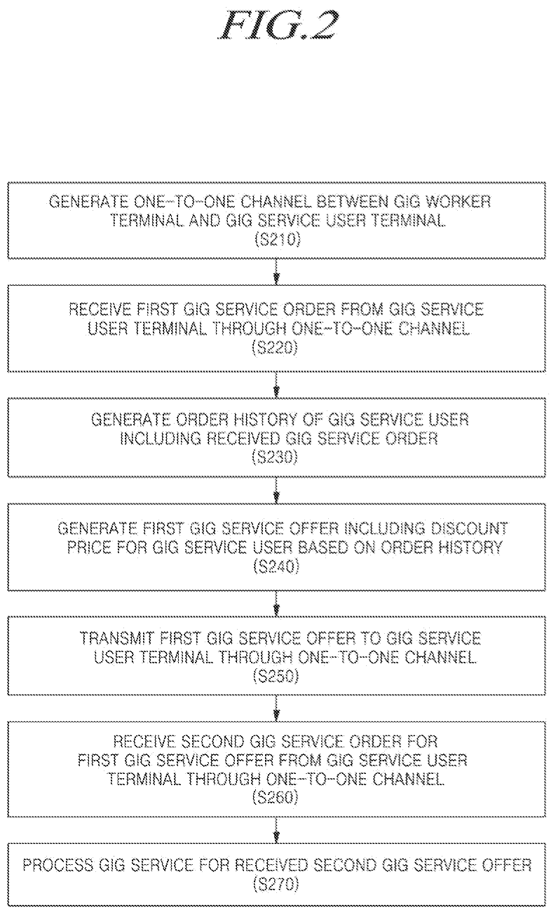

FIG. 2 is a flowchart schematically illustrating a method for providing a gig service through a one-to-one channel between a gig worker and a gig service user according to an embodiment of the present invention.

In step 210, the gig service providing device 100 generates the one-to-one channel between the gig worker terminal and the gig service user terminal. The one-to-one channel according to an embodiment of the present invention may be generated through a web or a dedicated application in the gig service providing device 100, but is not limited thereto. The one-to-one channel includes all means capable of one-to-one communication between the gig worker and the gig service user.

In step 220, the gig service providing device 100 receives a first gig service order from the gig service user terminal through the one-to-one channel.

In step 230, the gig service providing device 100 generates an order history of the gig service user including the received first gig service order.

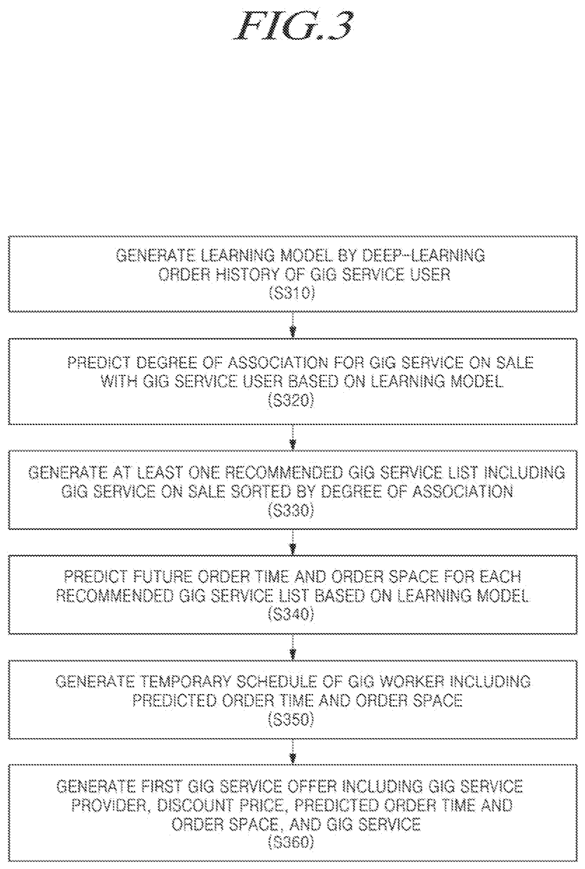

In step 240, the gig service providing device 100 generates a first gig service offer including a discount price for the gig service user based on the order history. A detailed flowchart of step 240 is described below with reference to FIG. 3.

In step 250, the gig service providing device 100 transmits the first gig service offer to the gig service user terminal through the one-to-one channel.

In step 260, the gig service providing device 100 receives a second gig service order for the first gig service offer from the gig service user terminal through the one-to-one channel.

In step 270, the gig service providing device 100 processes a gig service for the received second gig service order.

FIG. 3 is a flowchart illustrating generating a customized gig service offer including a discount price for a gig service user for whom a one-to-one channel has been generated according to an embodiment of the present invention.

In step 310, the gig service providing device 100 generates a learning model by deep learning the order history of the gig service user. The order history of the gig service user is composed of data including the ordered gig service, order time, order place, and order price. In the instant embodiment, the learning model 130 is trained by deep learning and, for deep learning training, uses at least one of a machine learning algorithm such as a random forest, a deep neural network (DNN), a convolutional neural network (CNN), a recurrent neural network (RNN), a restricted Boltzmann machine (RBM), a deep belief network (DBN), or a deep Q-networks (DQN), but is not limited thereto.

The learning model further generates a learning model for a gig service on sale. The gig service includes at least one of type, detailed information, desired price, order history information, and gig service provider information. The order history information includes data on the orderer, the order time, the order place, and the order price.

Specifically, the learning model is generated by a vector generator and a learning model unit.

The vector generator generates an order history feature vector and a gig service feature vector of the gig service user, including at least one feature vector representing each attribute value, based on the order history data and the gig service data of the gig service user.

The learning model unit learn, based on the order history feature vector of the gig service user and the gig service feature vector, a degree of association between the gig service on sale and the gig service user, indicating the purchaseability of the gig service user for the gig service data. According to an embodiment of the present invention, it is obvious to one of ordinary skill in the art that the degree of association between the gig service user and the gig service on sale may be learned by calculating a similarity between the order history feature vector of the gig service user and the gig service feature vector using a matrix similarity or a neural network technology, and various learning techniques may be used without being limited to a specific technology.

In step 320, the gig service providing device 100 predicts a degree of association for the gig service user and a gig service on sale, indicating the gig service user's purchaseability for the gig service on sale based on the learning model.

In step 330, the gig service providing device 100 generates a recommended gig service list including at least one selling gig service sorted (or aligned) with the degree of association between the gig service user and the selling gig service, for the gig service user.

In step 340, the gig service providing device 100 predicts a future order time and order space for each of the recommended gig service lists, based on the learning model.

In step 350, the gig service providing device 100 generates a temporary schedule of the gig worker including the order time and the order space. The gig service providing device 100 obtains a discount price based on an external input of the gig worker for orders that may be simultaneously processed due to overlapping or successive occurrences in the temporary schedule of the gig worker.

In step 360, the gig service providing device 100 generates a first gig service offer including the recommended gig service, the predicted order time, the predicted order space, the discount price, and the gig service provider. The first gig service offer includes a gig service provider and a discount price for the gig service user, generated based on one gig service in the recommended gig service list, the predicted order time, the predicted order space, and the temporary schedule.

When the second gig service order is received from the gig service user terminal in step 260 for the first gig service offer transmitted to the gig service user terminal through the one-to-one channel in step 250, the gig service providing device 100 generates an actual schedule reflecting the temporary schedule of the gig worker. The gig service providing device 100 processes the gig service for the received second gig service order through the gig worker according to the actual schedule of the gig worker.

Meanwhile, the gig service providing device 100 according to an embodiment of the present invention generates a similar gig service user list including at least one other gig service user indicating an order history similar to the order history of the learned gig service user. To that end, the learning model unit further learns a gig service user association degree indicating a similar order pattern between the gig service users, based on the order history feature vector of each gig service user. According to the present embodiment, when the respective order history feature vectors of gig service users are similar to each other, it may be considered that the order patterns are similar between the gig service users, but it is obvious to those skilled in the art that there may be various other methods for determining similar order patterns.

The gig service providing device 100 according to an embodiment of the present invention transmits the first gig service offer to each of the at least one other gig service user terminal of the similar gig service user list.

According to the present embodiment, the gig service providing device 100 may additionally transmit a customized discount offer for the gig service user to a similar gig service user indicating an order history similar to the order history of the gig service user, thereby leading to lots of orders and hence maximizing the productivity of the gig worker.

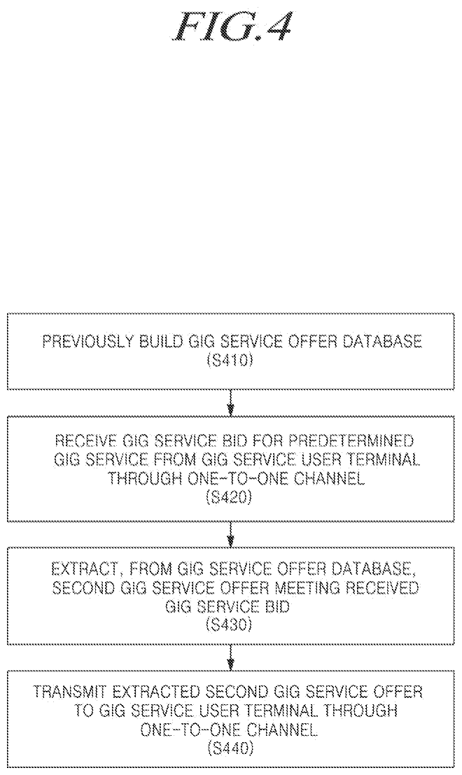

FIG. 4 is a flowchart schematically illustrating receiving a gig service bid from a gig service user for whom a one-to-one channel has been generated and generating a gig service offer according to an embodiment of the present invention.

In step 410, the gig service providing device 100 builds a gig service offer database for the gig service on sale. The gig service offer database includes gig service, order time, order space, order price, and gig service provider items. The gig service providing device 100 may previously build the gig service offer database based on external inputs of the gig worker and the gig service provider.

In step 420, the gig service providing device 100 receives a gig service bid for a predetermined gig service from the gig service user terminal through the one-to-one channel. The gig service bid includes a predetermined gig service, an order time, an order space, and an order price.

In step 430, the gig service providing device 100 extracts a second gig service offer meeting the received gig service bid from the gig service offer database. The second gig service offer includes a predetermined gig service, an order time, an order space, an order price, and a gig service provider.

In step 440, the gig service providing device 100 transmits the extracted second gig service offer to the gig service user terminal through the one-to-one channel.

As the gig service user may modify the gig service bid and retry the same, steps 420 to 440 may be repeated. As a result, as the gig service user accepts the second gig service offer, the gig service providing device 100 provides the corresponding gig service to the gig service user.

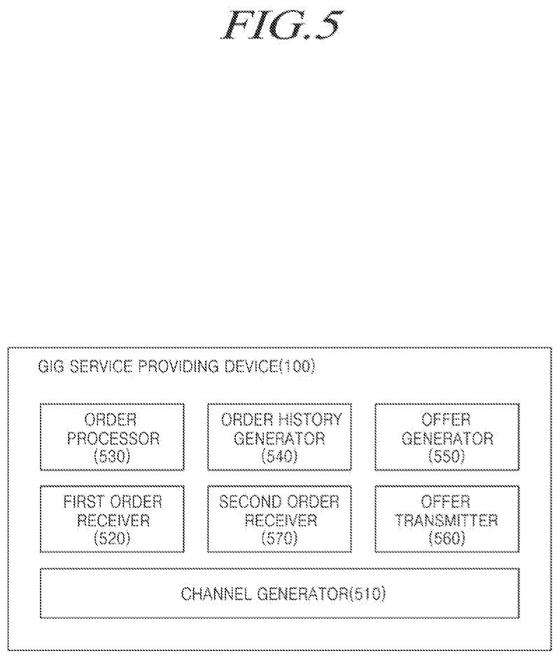

FIGS. 5 to 7 are block diagrams schematically illustrating a device for providing a gig service according to an embodiment of the present invention.

As illustrated in FIG. 5, the gig service providing device 100 according to an embodiment of the present invention includes a channel generator 510, a first order receiver 520, an order processor 530, an order history generator 540, an offer generator 550, an offer transmitter 560, and a second order receiver 570.

The channel generator 510 generates the one-to-one channel between a gig worker terminal and a gig service user terminal. The one-to-one channel according to the present embodiment may be generated through a web or a dedicated application in the gig service providing device 100, but is not limited thereto. The one-to-one channel includes all means capable of one-to-one communication between the gig worker and the gig service user.

The first order receiver 520 receives a first gig service order from the gig service user terminal through the one-to-one channel.

The order processor 530 processes the gig service for the received first gig service order.

The order history generator 540 generates the gig service user's order history including the received first gig service order.

The offer generator 550 generates a first gig service offer including a discount price for the gig service user based on the order history.

The offer transmitter 560 transmits the first gig service offer to the gig service user terminal through the one-to-one channel.

The second order receiver 570 receives a second gig service order for the first gig service offer from the gig service user terminal through the one-to-one channel.

The order processor 530 processes the gig service for the received second gig service order.

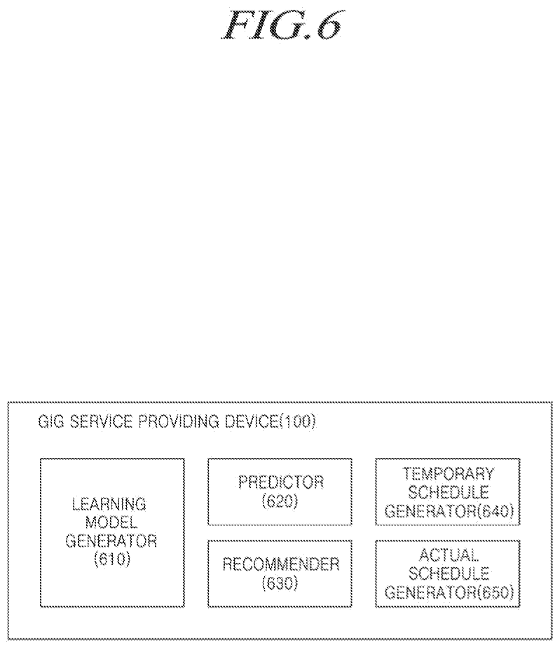

Meanwhile, in order for the offer generator 550 according to an embodiment of the present invention to generate the first gig service offer, as shown in FIG. 6, the gig service providing device 100 according to an embodiment of the present invention may further include a learning model generator 610, a predictor 620, a recommender 630, a temporary schedule generator 640, and an actual schedule generator 650.

The learning model generator 610 generates a learning model by deep-learning the gig service user's order history. The order history of the gig service user is composed of data including the ordered gig service, order time, order place, and order price. In the instant embodiment, the learning model 130 is trained by deep learning and, for deep learning training, uses at least one of a machine learning algorithm such as a random forest, a deep neural network (DNN), a convolutional neural network (CNN), a recurrent neural network (RNN), a restricted Boltzmann machine (RBM), a deep belief network (DBN), or a deep Q-networks (DQN), but is not limited thereto.

The learning model further generates a learning model for a gig service on sale. The gig service includes at least one of type, detailed information, desired price, order history information, and gig service provider information. The order history information includes data on the orderer, the order time, the order place, and the order price.

The learning model generator 610 includes a vector generator (not shown) and a learning model unit (not shown). The vector generator generates an order history feature vector and a gig service feature vector of the gig service user, including at least one feature vector representing each attribute value, based on the order history data and the gig service data of the gig service user. The learning model unit learn, based on the order history feature vector of the gig service user and the gig service feature vector, a degree of association between the gig service on sale and the gig service user, indicating the purchaseability of the gig service user for the gig service data.

The predictor 620 predicts a degree of association for the gig service user and a gig service on sale, indicating the gig service user's purchaseability for the gig service on sale based on the learning model.

The recommender 630 generates a recommended gig service list including at least one selling gig service sorted (or aligned) with the degree of association between the gig service user and the selling gig service, for the gig service user.

The predictor 620 further predicts a future order time and order space for each recommended gig service list based on the learning model.

The temporary schedule generator 640 generates a temporary schedule of the gig worker including the order time and the order space. The gig service providing device 100 obtains a discount price based on an external input of the gig worker for orders that may be simultaneously processed due to overlapping or successive occurrences in the temporary schedule of the gig worker.

The first gig service offer generated by the offer generator 550 includes a gig service provider and a discount price for the gig service user, generated based on one gig service in the recommended gig service list, the predicted order time, the predicted order space, and the temporary schedule.

When the second order receiver 570 receives the second gig service order from the gig service user terminal for the first gig service offer transmitted by the offer transmitter 560 to the gig service user terminal through the one-to-one channel, the actual schedule generator 650 generates an actual schedule reflecting the temporary schedule of the gig worker. The order processor 530 processes the gig service for the received second gig service order through the gig worker according to the actual schedule of the gig worker.

The gig service providing device 100 according to the present embodiment may further include a similar gig service user list generator (not shown).

The similar gig service user list generator generates a similar gig service user list including at least one other gig service user indicating an order history similar to the order history of the learned gig service user. The offer transmitter 560 may further transmit the first gig service offer to each of the at least one other gig service user terminal of the similar gig service user list.

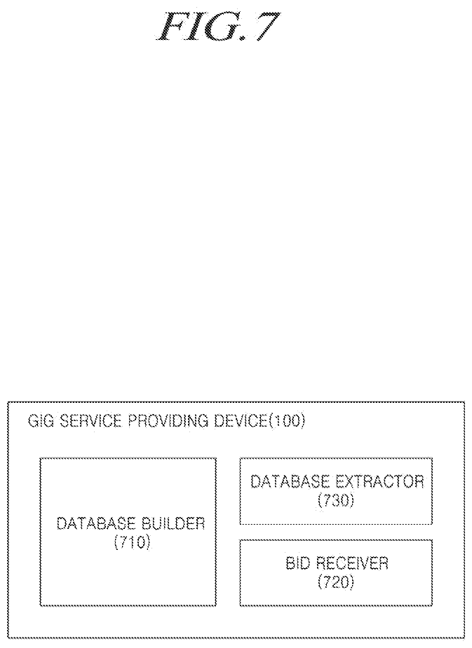

Meanwhile, as illustrated in FIG. 7, the gig service providing device 100 according to an embodiment of the present invention may further include a database builder 710, a bid receiver 720, and a database extractor 730.

The database builder 710 builds a gig service offer database for the gig service on sale. The gig service offer database includes gig service, order time, order space, order price, and gig service provider items. The database builder 710 may previously build the gig service offer database based on external inputs of the gig worker and the gig service provider.

The bid receiver 720 receives a gig service bid for a predetermined gig service from the gig service user terminal through the one-to-one channel. The gig service bid includes a predetermined gig service, an order time, an order space, and an order price.

The database extractor 730 extracts a second gig service offer meeting the received gig service bid from the gig service offer database. The second gig service offer includes a predetermined gig service, an order time, an order space, an order price, and a gig service provider.

The offer transmitter 560 transmits the extracted second gig service offer to the gig service user terminal through the one-to-one channel.

Although preferred embodiments of the present invention have been described above in detail, the scope of the present invention is not limited thereto, and various modifications and equivalent other embodiments are possible. Thus, the true technical scope of the present invention should be defined by the appended claims.

For example, a device according to an example embodiment of the present invention may include a bus coupled to each of the units of the device as shown, and at least one processor coupled to the bus and may include a memory coupled to the bus to store commands, received messages, or generated messages and coupled to the at least one processor to perform the above-described commands.

Further, the system according to the present invention may be implemented as computer-readable code in a recording medium. The computer-readable recording medium includes all types of recording devices storing data readable by a computer system. The computer-readable recording medium includes a magnetic storage medium (e.g., a ROM, a floppy disk, or a hard disk) or an optical reading medium (e.g., a CD-ROM or a DVD). Further, the computer-readable recording medium may be distributed to computer systems connected via a network, and computer-readable codes may be stored and executed in a distributed manner.

1. A method for providing a gig service through a one-to-one channel between a gig worker and a gig service user, the method comprising:
generating the one-to-one channel between a gig worker terminal and a gig service user terminal;
receiving a first gig service order from the gig service user terminal through the one-to-one channel;
generating the gig service user's order history including the received first gig service order;
generating a first gig service offer including a discount price for the gig service user based on the order history;
transmitting the first gig service offer to the gig service user terminal through the one-to-one channel;
receiving a second gig service order for the first gig service offer from the gig service user terminal through the one-to-one channel; and
processing a gig service for the received second gig service order.

2. The method of claim 1, further comprising:
generating a learning model by deep-learning the gig service user's order history;
predicting a degree of association for the gig service user and a gig service on sale, indicating the gig service user's purchaseability for the gig service on sale based on the learning model; and
generating a recommended gig service list including at least one gig service on sale, sorted by the degree of association for the gig service user and the gig service on sale, for the gig service user.

3. The method of claim 2, further comprising:
predicting a future order time and order space for each recommended gig service list based on the learning model; and
generating a temporary schedule of the gig worker including the order time and the order space.

4. The method of claim 3, wherein the first gig service offer includes a gig service provider and a discount price for the gig service user, generated based on one gig service in the recommended gig service list, the predicted order time, the predicted order space, and the temporary schedule.

5. The method of claim 3, further comprising generating an actual schedule reflecting the gig worker's temporary schedule when receiving the second gig service order from the gig service user terminal through the one-to-one channel.

6. The method of claim 4, further comprising:
generating a similar gig service user list including at least one other gig service user showing an order history similar to the order history of the learned gig service user; and
transmitting respectively the first gig service offer to a terminal of the at least one other gig service user in the similar gig service user list.

7. The method of claim 1, further comprising:
previously building a gig service offer database for the gig service on sale;
receiving a gig service bid for a predetermined gig service from the gig service user terminal through the one-to-one channel;
extracting a second gig service offer meeting the received gig service bid from the gig service offer database; and
transmitting the extracted second gig service offer to the gig service user terminal through the one-to-one channel.

8. The method of claim 7, wherein the gig service bid includes a predetermined gig service, an order time, an order space, and an order price, and
wherein the second gig service offer includes a predetermined gig service, an order time, an order space, an order price, and a gig service provider.

9. The method of claim 1, wherein the one-to-one channel is generated through a web or a dedicated application.

10. A device for providing a gig service through a one-to-one channel between a gig worker and a gig service user, comprising:
a channel generator generating the one-to-one channel between a gig worker terminal and a gig service user terminal;
a first order receiver receiving a first gig service order from the gig service user terminal through the one-to-one channel;
an order history generator generating the gig service user's order history including the received first gig service order;
an offer generator generating a first gig service offer including a discount price for the gig service user based on the order history;
an offer transmitter transmitting the first gig service offer to the gig service user terminal through the one-to-one channel;
a second order receiver receiving a second gig service order for the first gig service offer from the gig service user terminal through the one-to-one channel; and
an order processor processing a gig service for the received second gig service order.

11. The device of claim 10, further comprising:
a learning model generator generating a learning model by deep-learning the gig service user's order history;
a predictor predicting a degree of association for the gig service user and a gig service on sale, indicating the gig service user's purchaseability for the gig service on sale based on the learning model; and
a recommender generating a recommended gig service list including at least one gig service on sale, sorted by the degree of association for the gig service user and the gig service on sale, for the gig service user.

12. The device of claim 11, wherein the predictor further predicts a future order time and order space for each recommended gig service list based on the learning model, and
wherein the device further comprises a temporary schedule generator generating a temporary schedule of the gig worker including the order time and the order space.

13. The device of claim 10, further comprising an actual schedule generator generating an actual schedule reflecting the gig worker's temporary schedule when receiving the second gig service order from the gig service user terminal through the one-to-one channel.

14. The device of claim 12, wherein the first gig service offer includes a gig service provider and a discount price for the gig service user, generated based on one gig service in the recommended gig service list, the predicted order time, the predicted order space, and the temporary schedule,
wherein the device further comprises a similar gig service user list generator generating a similar gig service user list including at least one other gig service user showing an order history similar to the order history of the learned gig service user, and
wherein the offer transmitter further transmits the first gig service offer to a terminal of the at least one other gig service user in the similar gig service user list.

15. The device of claim 10, further comprising:
a database builder previously building a gig service offer database for the gig service on sale;
a bid receiver receiving a gig service bid for a predetermined gig service from the gig service user terminal through the one-to-one channel; and
a database extractor extracting a second gig service offer meeting the received gig service bid from the gig service offer database,
wherein the offer transmitter further transmits the extracted second gig service offer to the gig service user terminal through the one-to-one channel.
